(19) United States
(12) Patent Application Publication
(10) Pub. No.: US 2011/0233375 A1
(43) Pub. Date: Sep. 29, 2011

(54) Washer Suspension

(75) Inventor: Martin Ortega Breña, Santiago de Queretaro (MX)

(73) Assignee: MABE, S.A. DE C.V., Santiago de Queretaro (MX)

(21) Appl. No.: 13/070,882

(22) Filed: Mar. 24, 2011

(30) Foreign Application Priority Data
Mar. 26, 2010 (MX) MX/A/2010/003432

(51) Int. Cl. D06F 37/24; F16M 13/02; D06F 37/20

(52) U.S. Cl. 248/610; 248/560

(57) ABSTRACT

A link suspension coupled to a system is described which vibrates, which comprises at least four links supporting the system which vibrates by means of one Cardan joint and one foot, one articulation between the Cardan joint and the link, one articulation between each link, one articulation between the foot and a link; each articulation houses a spring. Further a cylinder and piston suspension is described coupled to a system which vibrates, which comprises a cylinder, a piston housed within the cylinder, an articulation fastened to an end of the cylinder and to a Cardan joint, an articulation fastened to another end of the piston and to a foot; a spring fastened to the cylinder and the piston, wherein the cylinder suspension is at an angle varying between 35° and 50° from the axis of symmetry of the system which vibrates.

### RELATED APPLICATIONS

This application claims priority from Mexican application Serial No. MX/a/2010/003432 filed Mar. 26, 2010, which is incorporated herein by reference in its entirety.

### FIELD OF INVENTION

The present invention relates to suspensions for washers, specifically to suspensions for automatic washers to avoid the effects of unbalance and to improve the isolation system.

### BACKGROUND

With the end purpose of the terms included in the following description be understood, the following glossary is presented which is related to FIG. 1:

Cabinet 1: Washer's outer structure which protects and supports the washing mechanism (sub-washer).

Impulse System: Set of parts which provide the washer with movement (motor 2, shaft 3, etc.).

Hydraulic System: Set of parts which are in contact with the water in the washer (tub 4, basket 5, bottom of the basket 6, etc.).

Basket 6: Receptacle in which clothes are placed within the washer.

Tub 4: Water container within which the basket is found.

Dynamic System: Set of parts of the washer which are in charge of controlling the reactions of the sub-washer to the movement of the operation (Balancing Ring 7 and suspension 10).

Piston: Part of the washer's suspension which is introduced within the cylinder and provides shock absorption upon having relative displacement between both these elements.

Cylinder: Part of the suspension on which the sub-washer braces on and where the piston is housed.

Balancing Ring 7: Part of the washer which is assembled unto the basket 5 and provides a counter-weight to the unbalancing charges during the centrifuge cycle.

Sub-washer: Assembly of the impulse, hydraulic and dynamic systems, which is found within the cabinet 1.

Agitator 8: Part in charge of providing the mechanical force which emanates from the motor 2 to the washing liquid and the clothes within the basket 5.

Control Panel 9: Panel where the operator controls the washer's actions.

In the previous art, the suspensions for vertical axis washers refer to two main concepts: hanging and lower. Within each one of these concepts, there exist many variations.

a. Hanging Suspensions

A hanging suspension has four similar assemblies which go from the corners of the washer's cabinet to four points on the tub. Each assembly is formed by an articulation, a rod, an element for rigidity (spring), shock absorbing elements (cylinder and piston) and diverse structural elements.

The main variants of a suspension refer to the way in which it is assembled and to the shock absorbing elements used. Other improvements are parts foreign to the suspension which control the excitations and in this way decrease the work for the suspension. Following, as series of varying patents of this type of suspension are discussed.

U.S. Pat. No. 6,460,381 B1 makes known a load sensor which works upon turning or displacing the coil of the electromagnet, this allows sensing of the load and the weight of the water which can act as a type of level sensor; placed in the cabinet, it is used to measure vibrations and unbalancing effects. Upon being able to measure these variables, the sensors are capable of sending the information to the washer's control. For example, if excessive vibration occurs during centrifuge, the control decreases or increases the gyrating velocity of the basket. The elements marked number 1 of said patent, refer to the load sensors placed on the upper part of the suspension assembly.

U.S. Pat. No. 6,193,225 B1 makes known a sectioned, non-circular spring with non-linear behavior. This is achieved by means of a rectangular section whose length and width dimensions vary along the length of the spring's longitude. This results in a variable spring rate. Having a variable spring rate aids in making a system more rigid when the displacements in the suspension increase, resulting in an improved performance of the suspension. FIG. 3 of said patent shows the spring.

U.S. Pat. No. 5,937,676 makes known a suspension system with a main upper suspension and a main lower suspension. A secondary suspension on the adjacent sides to the main suspensions, provide the shock absorption and has a hollow rubber cylinder and foam within the rubber element. The rubber elements present a viscous-elastic behavior which provides rigidity and energy dissipation in a simultaneous manner. In FIG. 1 of said patent, the elements marked number 600 are the rubber cylinders. FIG. 2 of said patent shows these elements in detail.

U.S. Pat. No. 5,887,455 makes known the use of various shock absorbers in two different dispositions; one in parallel where both shock absorbers hang from a same rod and are connected by a bar at the end of this. The other has eight sets of rods, springs and shock absorbers, a pair hanging from each of the cabinet's corners but at differing heights. This patent attempts to provide a washer with two different shock absorbing constants. In FIG. 1 of said patent, the elements marked number 10 are the spring shock absorbing systems for a suspension assembly.

U.S. Pat. No. 5,606,879 makes known the use of a retainer spring which includes a series of unleveled beams with the objective of ensuring that the skirt of the piston has greater contact with the cylinder's walls. In FIGS. 2, 3 and 4 of said patent, the element marked 52 is the retainer spring which is inserted into the lower part of the piston 46.

Canadian Patent number 2,513,229 proposes that the upper support of the beams be fastened by an elastomer which provides shock absorption and non-linear restitution, with the objective of ensuring that the rod be in contact at all moments with the support of the same. FIG. 5 of said patent shows a section view of the upper part of a suspension assembly. The element marked number 70 refers to the elastomeric piece unto which the rod 22 is inserted.

U.S. Pat. No. 4,625,529 makes known a suspension with couplings to the tub which allows a certain amount of angular movement between the parts in a limited range of movement; the restrictions intend to decrease the gyrations of the sub-washer relative to the cabinet within certain limits. FIG. 1 of said patent shows an assembly where the elements 22 correspond to the couplings which restrict the movement.

U.S. Pat. No. 6,397,643 makes known a suspension assembly which contains elements which allow for a change in the shock absorption. The element is placed surrounding the suspension rods and these are compressed depending on the variations to the wash load in the tub, thus changing the shock absorption capacity. An elastic material is placed between the shock absorption element and the base of the shock absorber. FIG. 5 of said patent shows element 84 which corresponds to the piece which is deformed with the wash load and in turn compresses the element 93, which is in contact with the rod 60 and provides shock absorption.

US Publication number 2006/0026771 describes a shock absorption system which provides energy dissipation in two degrees of liberty. FIG. 5 of said patent shows the shock absorber which is formed by an elastomer 138 within which a rigid element 106 is contained which is connected to the sub-washer. The lower end of the shock absorber is fixed unto the cabinet 104.

U.S. Pat. No. 5,893,281 makes known a tying system for a sub-washer to avoid torsion of the same during the breaking of the basket. It also decreases the oscillation during the agitation cycle and the low velocity centrifuge. FIG. 1 of said patent shows a lateral view of a washer where the tie 38 surrounds the tub 18 and restricts its oscillatory movement.

U.S. Pat. No. 5,884,891 makes known an upper restraint system for the suspension formed by a spherical joint and a concave articulation which receives the spherical joint. FIGS. 2 and 3 of said patent, show the concave part of the articulation 62 assembled to the cabinet 36 and in turn the convex part of the articulation 86 assembled to the concave part. These provide a sliding surface on the upper part of the suspension.

U.S. Pat. No. 5,117,659 makes known the fastening for the shock absorber system which provides variable shock absorption depending on the displacement of the sub-washer by means of a variable inter-phase. FIG. 3 of said patent shows the suspension assembly where the shock absorbing element 64 makes contact with the rod and depending on the load, this element pressures the rod in a greater or a lesser degree thus making the shock absorption variable.

U.S. Pat. No. 5,946,946 makes known a suspension system with variable shock absorption through one piece which upon being displaced tightens against the suspension rod. This provides it with a capacity to better dissipate vibrations. FIG. 3 of said patent shows a sectional view of the shock absorber where the element 55 makes contact with the rod 36 and depending on the load it either increases or decreases the shock absorption.

U.S. Pat. No. 4,854,559 makes known a shock absorber linear by friction parallel to a heliocoidal spring. It controls the run in such a way that it provides greater shock absorption in the transitory zones, when the amplitudes are greater.

a. Lower Suspension

A lower suspension has at least three supports which go from the tub's lower part to the bottom of the cabinet in the washer. Each one of the supports has of at least one spring and one parallel shock absorber. In the previous art, there are various patents which make known lower suspensions for washers, such as U.S. Pat. Nos. 3,939,674 and 3,729,960 and 3,912,207.

All patents previously mentioned focus in optimizing a variable of the suspension be it hanging or anchored to the floor. Many of these patents have been used in commercial products and some others are mainly ruled out by the aspect of cost and performance.

None of the patents previously mentioned represent a different concept to what is already known. The manner in which vibrations are controlled does not change form springs and shock absorbers by friction in parallel.

Scientific Investigation of Prior Art

Scientific articles related to suspensions and the physical principles of shock absorption by friction and air compression were searched.

One alternative for improvement of air suspension is presented in “An improved design of Air suspension for seats of mobile agricultural machines”. This includes an air spring with additional air volume and variable air shock absorption.

Conventional suspensions are called passive due to their having a fixed rigidity and fixed shock absorption. These types of suspensions have problems when the systems connected to them have a great variability of excitations. To solve this problem, active suspensions were created in which both rigidity as well as shock absorption is controlled. This type of suspension has great performance but has the disadvantage of requiring energy introduction to the system to control the actuators. An intermediate solution to the problem is semi-active suspensions which vary some of the parameters without introducing energy to the system. Currently, there is a tendency to explore with semi-active suspension systems.

In the work “A controlled friction damper for vehicle applications” the performance of a shock absorber by servo-actuated friction in an automotive application is examined. The shock absorber is a semi-active type, that is, the shock absorber is controlled without introducing energy to the system and as such, the energy required is much lesser than the energy required in an active system. It is shown by means of simulation and experimental studies that a shock absorber by controlled friction has a potentially higher performance than a conventional shock absorber.

Another interesting work is “Semi-Active damping control of suspension systems for specified operational response”, where a semi-active control law is formulated with an on-off type with semi-active actuators for vibration attenuation in a natural suspension system with multiple degrees of liberty, when its type of operational response is specified. The advantage of this development is that it does not need exact parameters for the system nor dynamic for semi-active actuators. The system reduces vibrating energy of the system including the work exerted by outer forces and the semi-active actuator adjusts itself to obtain the greatest energy dissipation.

Continuing with semi-active suspensions, in “Semi-active control of friction Dampers (8)”, where the control laws for shock absorbers are proposed which maximize dissipated energy in an instant direction modulating normal force in the friction inter-phase. For the design of the control law several frictional dynamic effects are considered induced by displacement and velocity. A dynamic control is proposed which prevents the accumulated frictional energy be returned to the system.

A semi-active apparatus for vibration control for machinery and vehicle foundations is proposed in “Vibration Control of machines by use of semi-active dry friction damping”. Using a dry, semi-active friction shock absorber and a type of sequential shock absorber, with logical balance and a type of sequential shock absorption, the transmitted force is minimized. The force of friction applied to the mass is controlled in such a way that the force of the spring is dissipated. The friction can be controlled to imitate a viscous shock absorber. The results of numeric simulations show significant reduction of the forces transmitted to the foundations of a machine or the average acceleration of a vehicle in a route of random excitations.

One of the main problems for the modeling and design of the suspension for a washer is the lack of linearity of the system. As is presented in “Nonlinear dynamics of parts in engineering systems”, the washer presents Coulomb friction on contact with the floor, impacts from de-balancing masses within the basket, nonlinear springs and nonlinear shock absorbers. Additionally, the washer can present sliding and jumping during the course of operations. Given that theses phenomenon are nonlinear, it is necessary to deepen in the nonlinear models of these systems. The lack of linearity in shock absorbers by friction is due in part to the phenomenon of stick-slip. This phenomenon refers to when during relative movement between bodies in contact, there are occasions when there is slipping and other instants when the relative movement is interrupted called sticking. The functioning ideal of a shock absorber by friction is that displacement always exists to be able to dissipate the greatest amount of energy.

The feasibility of a shock absorber by adjustable friction is presented in “Feasibility study of a tunable friction damper”. The design combines the advantages of a shock absorber by friction, which dissipates energy by means of sliding friction, and a vibration shock absorber of mass-spring type, which absorbs energy by means of its own vibration. The shock absorber by adjustable friction functions as a shock absorber by friction while the mass slides and as a vibration absorber when the mass gets stuck, where generally a shock absorber by conventional friction stops working. The most important advantage of this design is that it can be adjusted to lower the vibrations in a determined frequency range while it can also provide shock absorption for a wide range.

For suspension design it is always important to know the parameters of the suspension, the rigidity and shock absorption.

“An explicit frequency response function formulation for multi-degree-of-freedom nonlinear systems” presents a technique for the explicit formulation of Frequency Response Functions (FRFs) for systems of multiple degrees of freedom for nonlinear systems. The technique produces FRFs in the selected coordinates, where the size of the system is not important or the type of nonlinearity. An improved version of the technique, which can handle large systems, is presented and valid against real measurements taken from a test platform.

The simulation packets play an important role in the analysis of nonlinear systems. A simulation packet, simulation language, simulator, system of simulation or simulation ambiance is a computer program created for simulation of dynamic systems at a higher level than that which programming languages can accomplish. The different terminology used reflects more or less the development of this type of special packets, however, unfortunately in literature, these terms are mixed-up. A simulation is a method to resolve a problem in dynamic systems which investigates, instead of a real system, a model of the system.

The simulation system used for this invention, which shall be described briefly, is classified as a pre and postprocessor of dynamic simulations of multi-body dynamics, MBD, as well as a solver of the made models.

FIG. 2 shows a diagram of the way in which the simulation is carried out. Specifically, it shows that it has a pre-processor where data is input for the construction of a model. The solver can be local or external. Finally, there is a post-processor which is shown in the built model and is animated with real variables.

### BRIEF DESCRIPTION OF THE INVENTION

A suspension is described, preferably for automatic washers with a vertical or horizontal axis, upon using a plurality of parameters to be considered as undergoing in a method. The method, comprises among its steps, the receiving of the system's parameters, the developing the design concept, the developing of the prototype, the experimenting the prototype and the simulating of the prototype.

The new suspension concept emerges from the need to have a better washer performance. The current suspension concept has advantages in simplicity and number of pieces. However, it has limits regarding dynamic performance in the transitory states in the centrifuge cycle. With the gradual increase of capacity and the centrifugal velocity of washers, the forces involved in the system dynamics increase in drastic amounts and create new isolating needs.

There are two general ways to solve the dynamic problems for a washer: adjust the system so that it will not create unbalancing, or improve the isolating system so that these unbalances are non-perceptible. Depending on the problem shall be the complexity to resolve it by one or another means. The present invention focuses on the suspension to improve the washer's dynamic through the improvement of isolation, that is, the suspension.

The suspension proposed is a hanging suspension which controls six degrees of freedom for the sub-washer. To accomplish this, the following objectives are proposed:
The number of springs in the suspension shall be minimal to avoid having a large number of natural frequencies;
The number of articulations must be the minimum; and
The length of the suspension must be the minimum to avoid flexion and lever arms which shall create large moments.

The hanging suspension being proposed comprises a cylinder, a piston within the cylinder, at least one spring on the outer part of the cylinder and at least two articulations on the ends of the cylinder and the piston. The hanging suspension is placed at a determined height of the washtub and at a determined angle.

### BRIEF DESCRIPTION OF THE FIGURES

These and other characteristics, aspects and advantages of the present invention will be better understood when the following detailed description is read referencing the accompanying figures, of which:

FIG. 1 is a view in conventional perspective of a cross section of a washer showing the parts of the same.

FIG. 2 is a diagram of a simulator.

FIG. 3 is a cross section and upper view showing the function scheme of the balancing ring.

FIG. 4 is a function scheme of the balancing ring with balls.

FIG. 5 is a cross section of a washer showing the balancing of a washer on two planes.

FIG. 6 is a scheme of the proposed methodology.

FIG. 7 is a diagram of suspension of one single DOF.

FIG. 8 is a diagram of a chain of links in parallel.

FIG. 9 is a view in perspective of a washer and the actual suspension of a washer in detail.

FIG. 10 is a diagram of the topology of a suspension of previous art.

FIG. 11 is a diagram of actual suspension without redundant degrees.

FIG. 12 is a view in cross section of a shock absorbing spring in parallel.

FIG. 13 is a front view of the suspension of links and rotational articulations concept for a first embodiment of the suspension.

FIG. 14A is an upper view of the suspension in FIG. 13 showing the degrees of freedom of the links.

FIG. 14B is a lower view of the suspension in FIG. 13 showing the degrees of freedom in the lower Cardan joint.

FIG. 15 is a detailed view of the suspension in FIG. 13 showing the housing of springs in suspension.

FIG. 16 is a graph showing a topological scheme of the suspension of the first embodiment.

FIG. 17 is a lateral view of the cut bodies in a sub-washer with the suspension of the first embodiment.

FIG. 18 is a detailed view of the suspension of FIG. 13, specifically of the upper Cardan joint and the primary link, showing the phenomenon of nonlinearity in the arrangement of torsion springs.

FIG. 19 is a graph showing the rigidity curve versus the distance in the first embodiment of the suspension.

FIG. 20A is an upper view of a bidirectional torsion spring for the first embodiment.

FIG. 20B is a lateral view of a bidirectional torsion spring for the first embodiment.

FIG. 21 is a view in conventional front perspective of the housing of the torsion springs in each one of the links of the first embodiment.

FIG. 22 is a view in conventional perspective of the first embodiment of the suspension mounted on a tub.

FIG. 23 is a graph of the force of braces of the suspension for the base line and for the suspension of the first embodiment.

FIG. 24 is a lateral view of the second embodiment of the suspension.

FIG. 25 is a detailed view of the suspension showing the degrees of freedom of the second embodiment.

FIG. 26 is a topologic scheme of the second embodiment.

FIGS. 27A and 27B are comparative views of the position of the springs for the suspension of previous art and the suspension of the second embodiment.

FIG. 28 is a lateral view showing the bodies cut in the second embodiment.

FIG. 29 is a comparative graph of the force for braces for the suspension of previous art and for the suspension of the second embodiment.

FIG. 30 is a comparative graph of the sliding in the tub for the suspension of previous art and for the suspension of the second embodiment.

FIG. 31 is a view of the optimizing variables of the new concept in the second embodiment.

FIG. 32 is a graph of the response surface to sliding for the second embodiment.

FIG. 33 is a graph of the response surface to force for the second embodiment.

FIG. 34 is a comparative graph of the tub's sliding of the suspension in previous art and of the second embodiment.

FIG. 35 is a comparative graph of the force of the rod and of the suspension in previous art and of the second embodiment.

FIG. 36 is a comparative view of the initial configuration of the second embodiment and the optimal configuration of the second embodiment.

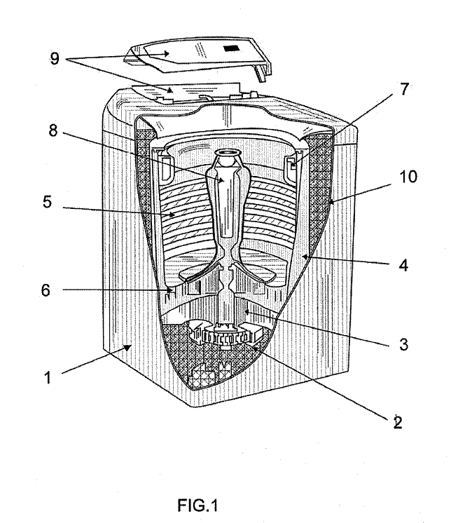

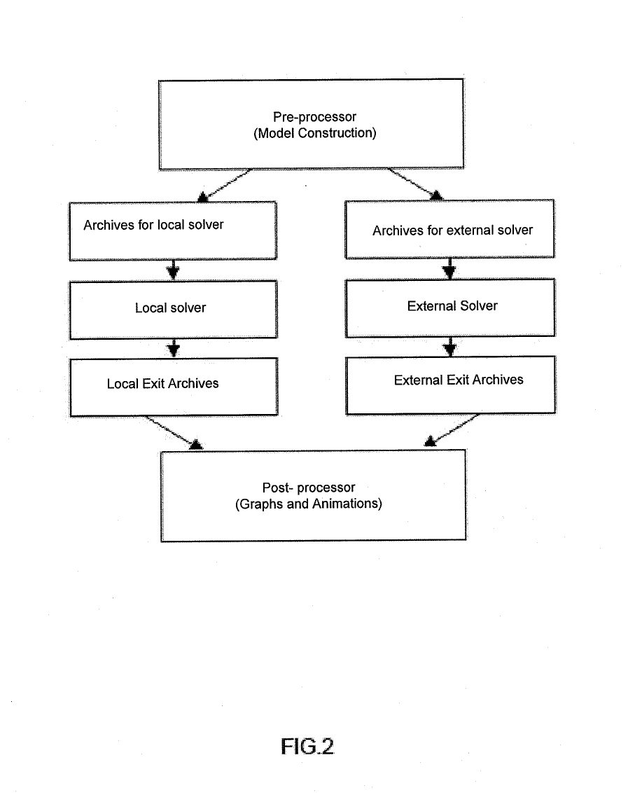

### DETAILED DESCRIPTION OF THE INVENTION

The present invention refers to washer suspensions in automatic washers with vertical or horizontal axis.

### DEFINITIONS AND CONCEPTS

“Suspension” is the term given to the system of springs, shock absorbers and links that connect a system with the ground. The suspension systems also have two purposes; contributing to washer performance and maintaining the support structure isolated from undesired vibrations. These goals are generally opposed. If the suspension is adjusted to achieve high performance, it could be that the vibrations are not efficiently isolated. On the contrary, if the suspension is adjusted for good isolation, it can decrease performance. Given the latter, the suspension design involves a balance between both characteristics.

Types of suspension: The suspension systems can be classified into passive, semi-active and active.

“Passive Suspensions” are used in the majority of the systems given their low cost and reliability. In this type of suspensions, the magnitude of rigidity of the spring and the shock absorption of the shock absorber remain within a determined ranged prescribed by the construction and the materials used for the same. However, these systems do not ensure the performance required by modern systems.

An improvement is achieved by using active or semi-active systems. The “semi-active systems” imply controlling rigidity or shock absorption. A conventional way for a semi-active shock absorber is a device in which the flow of viscous liquid varies between the chambers of the shock absorber. This is attained by means of actuated valves. Rigidity can be manipulated by means of a pneumatic chamber in which a pressure increase means a higher rigidity and vice-versa.

The “active systems” control both rigidity as well as shock absorption. These are used in a smaller number of applications since they are expensive and complex. Another disadvantage of the active systems is that they require high energy consumption. The use of linear electromagnetic actuators is one alternative for the active suspension systems. This solution has the advantage or recovering some of the energy.

Vibration: any movement which is repeated after a time interval is called vibration or oscillation. The vibration theory deals with the study of oscillatory movements of bodies and the forces associated with them.

A vibration system, generally, includes a means by which the accumulation of potential energy (spring or elasticity) is attained, a means to accumulate kinetic energy (mass or inertia) and a means through which energy is gradually lost (shock absorber).

The vibration of a system involves the transference of its potential energy into kinetic energy and it kinetic energy into potential energy alternating. If the system has shock absorption, part of the energy is dissipated in each vibration cycle and is replaced by an outside source if its stable state of vibration wants to be maintained.

Degrees of freedom of the system: The minimum number of independent coordinates necessary to completely determine the position of all the parts of a system at any given time instant.

Vibration can be classified in any given number of ways. Some classifications are mentioned below.

Free Vibration: If a system after having an initial disturbance is allowed to vibrate on its own, the vibration is known as a free vibration. No external force is acting on the system. The oscillation of a simple pendulum is an example of free vibration.

Forced Vibration: If a system is subjected to an outside force (generally a repetitive one), the resulting vibration is known as a forced vibration. Oscillation generated in diesel motor machines is an example of forced vibration.

If the frequency of the external force coincides with the natural frequency of the system, a condition known as resonance occurs, and the system is subject to dangerously large oscillations. Faults in structures such as buildings, bridges, turbines and airplane wings have been associated with the resonance phenomenon.

Vibration without Shock Absorption: A situation in which energy loss or dissipated with friction or any other resistance during oscillation does not exist.

Vibration with Shock Absorption: A situation in which any energy is lost on the way.

In many physical systems, the amount of shock absorption is so low that it can be discounted for engineering purposes. However, the consideration of shock absorption becomes increasingly important when vibration systems close to resonance are analyzed.

If all the basic components of a vibration system—the spring, the mass and the shock absorber—behave in a linear manner, the resulting vibration is known as linear vibration. However, if any of the basic components behaves in a non-linear manner, the resulting vibration is called non-linear. The differential equations which cover the behavior of linear and non-linear vibrating systems are linear and non-linear respectively.

Determinative Excitation: The value or magnitude of the excitation which acts upon a known vibrating system for a determined period of time. The resulting vibration is known as determinative excitation.

In some cases, the excitation is not determinative and is known as random. The value of excitation cannot be determined for a determine period of time. In these cases, a great number of samples of the excitation could exhibit regularity statistically. It is possible to estimate averages as the mean or the square mean of the excitation. If the excitation is random, the resulting vibration is known as random vibration. In the case of random vibration, the vibration response of the system is also random: it can be described only in terms of statistical quantity.

A “Vibratory System” is a dynamic system in which variables, such as excitations (entries) and the responses (exits) are dependent on time. The response of a vibration system generally depends on the initial conditions as well as on the external excitations. Given the complexity of a vibration system, only the most important aspects of the analysis are considered to predict the behavior of the system under specific entry conditions. Frequently, the general behavior of the system can be determined considering a simpler model of a complex physical system.

A “linear spring” is a type of mechanical connection to which a depreciating mass and shock absorption are generally assigned. A force is generated on the spring each time relative movement exists between the two ends of the spring. The force of the spring is proportional to the amount of deformation and is given by:

F=kx (1)

Where F is the force of the spring, x is the deformation (displacement of one end respective the other end), and k is the rigidity of the spring or constant of the spring. If the force and the displacement are graphed, the result is a line according to equation 1. The work accomplished (U) in deforming a spring is accumulated as potential energy and is given by:

U=½k^{x}^{²} (2)

In reality, the springs are nonlinear and behave according to equation 2 only up to a certain deformation value. After a certain deformation value, the force exceeds the cadence point of the material and the force displacement relation becomes nonlinear.

It is assumed that the “mass element” or inertia is a rigid body; it can gain or lose kinetic energy as long as the velocity of the body changes. From the second of Newton's laws of Movement, the product of mass and acceleration is equal to the force applied to the mass. The work is equal to the force multiplied by displacement in the direction of the force, and the work on the mass is accumulated in the form of kinetic energy.

Types of Shock Absorbers

In many real systems, the vibration energy is gradually converted into heat or sound. Given to this reduction in energy, the response, as well as the displacement of the system, gradually decreases. The mechanism by which the vibration energy is gradually converted into heat or sound is known as “Shock Absorption”. Even though the amount of energy converted into heat or sound is relatively small, upon considering shock absorption, it becomes important for a more certain prediction of the vibration response to a system. It is assumed that a shock absorber has neither mass nor elasticity and that the shock absorbing force only exists if a relative velocity between the two ends of the shock absorber exists.

The “Viscous Shock Absorber” is the shock absorbing mechanism most commonly used in the analysis of vibrations. When the mechanical systems vibrate in fluid means such as air, gas, water and oil, the resistance offered by the fluid to the movement of the body causes the energy to dissipate. In this case, the amount of energy dissipated depends on various factors, such as the size and the form of the body which vibrates the fluid viscosity, the frequency of vibration and the vibration velocity. In the viscous shock absorption, the force of the shock absorption is proportional to the velocity of the vibrating body. Typical examples of viscous shock absorption are (1) fluid film between two plates, (2) fluid surrounding a piston in a cylinder, (3) fluid through an orifice and (4) fluid film surrounding a bearing.

In the Coulomb Shock Absorber” or “shock absorption by friction”, the force of the shock absorption is constant in magnitude but opposite the direction of movement to the vibrating body. It is caused by the friction between two surfaces within contact that are either dry or have insufficient lubrication.

“Hysteretic Shock Absorption” or “of material or solid” refers to when materials are deformed and the energy is absorbed and dissipated by the material. The effect is due to the friction between the inner planes which slide when the deformation takes place. When a body which has material shock absorption is subject to vibration, the deformation force diagram presents a hysteretic cycle. The area within this cycle denotes the energy lost by a body's unit volume per cycle due to shock absorption.

Systems with Multiple Degrees of Freedom

Most systems in engineering are continual and have an infinite number of degrees of freedom. The vibration analysis of continuous systems requires the solution of partial differential equations, which is really complicated. In fact, the analytic solutions do not exist for many of the partial differential equations. On the other hand, the analysis of systems with multiple degrees of freedom requires the solution of a set of ordinary differential equations, which is relatively simple. Due to this, continuous systems are simplified as systems with multiple degrees of freedom.

There exists a movement equation for each degree of freedom; if generalized coordinates are used, there is a system of generalized coordinates for each degree of freedom. The movement equations can be obtained from the Second of Newton's Laws of movement or using an influence coefficient. However, generally it is more convenient to derive the movement equations from a system of multiple degrees of freedom using Lagrange equations.

There are multiple natural frequencies, each one associated with its own modal form for a system of n degrees of freedom. The method to determine the natural frequencies of a characteristic equation is obtained by equaling the determinant to zero. However, as the number of degrees of freedom increase, the solution to the characteristic equation becomes more complex. The model forms exhibit a property called orthogonality, which generally allows the analysis of multiple degrees of freedom to be simplified.

Several different methods can be used to make a continuous system be closer to a system of multiple degrees of freedom. A simple method involves replacing the masses or distributed inertias of the system to a finite number of concentrated masses or rigid bodies. It is assumed that the concentrated masses are connected by rigid and shock absorbing elements which lack mass. The linear or angular coordinates are used to describe the movement of the concentrated masses (or rigid bodies). The minimum number of coordinates to describe the movement of the concentrated masses and rigid bodies defines the number of degrees of freedom of the system. Naturally, the larger the number of concentrated masses used in the model, the higher the exactness of the analysis.

A popular method to approximate a continuous system is a system with various degrees of freedom which involves replacing the geometry of the system by a high number of small elements. Assuming a simple solution for each element, the compatibility principles and equilibrium are used to find an approximate solution to the original system. This method is called the Finite Element Method.

### Washer Dynamic

The washers themselves are a nonlinear system with multiple degrees of freedom. The amount of dynamically related parts is high, and additionally, there exist a series of variable systems in the washer. The main characteristics which make a washer be dynamically complex are the flexibility of the components, the nonlinear materials (plastics), the variable mass (clothes and water), the variable velocity and the dynamic balancing elements (fluids and solids).

The flexibility of the components refers to the majority of the washer parts being subject to dynamic charges are made of a plastic-elastic material. This characteristic allows for large displacements in these parts to exist when they are excited in their natural frequencies.

Automatic washers mainly have two cycles, one for washing and one for drying. Given that the washing cycle takes place at relatively low velocities (approximately 1 Hz) there are no major dynamic type problems. However, the washer's drying cycle (centrifuge) requires high velocities to be able to extract sufficient moisture from the clothes. During this cycle high frequencies of 20 Hz can be reached. These frequencies are sufficiently high to reach and surpass natural frequencies (resonance) of various washer components.

“Natural Frequencies”—As any system with multiple degrees of freedom, washers also have natural frequencies. Some parts have greater influence than others. The parts whose resonances have major effect on the washer are: the structure (cabinet), the rotor and the tub.

“Structure Frequency”—The structure, generally manufactured from some type of metal laminate, has faces which cover the washer's contour. These faces form membranes. The resonance of these membranes can cause the washer to “walk” and create undesirable noise to the operator. Given this, the structure is reinforced to avoid that the natural frequencies of the same lie in the same operational range as the washing machine. The reinforcement can be achieved via inlays in the laminate.

“Rotor Frequency”—The rotor is composed by all the parts which turn within the washer. Generally this rotor is formed by several parts, so that it is the way in which these parts are assembled which affects the behavior of the same. If the joints of the parts do not have the sufficient rigidity, the natural frequencies of the rotor are lowered and probably enter the operational range of the washing machine. Given that the rotor is the vibration excitation of the whole washer, a resonance fault within this can have catastrophic consequences to the washer's ability to function properly. Ideally, a washer's rotor should be the closest to complete rigidity.

### Tub Frequency

The tub is the element which connects the rotor to the suspension. Ideally, the tub should be made from a completely rigid element similar to the rotor. However, it is generally manufactured of a plastic material and its dimensions do not tend to grant it rigidity. A tub with low rigidity can accomplish absorbing rotor vibration and prevent its transmission towards the suspension. However, this can cause problems between the rotor and the tub. On occasions, undesired contact between these two elements can occur if either one of the two reaches resonance.

### Suspension Frequency

The suspension is an element which is designed to absorb the vibrations of the sub-washer and to avoid them from being transmitted to the cabinet. The suspension is formed by a mechanism of links and an isolator. The isolator is formed by a spring and a shock absorber. The natural frequency of this isolator is important in the design of the suspension. As opposed to other elements, the suspension cannot be rigid, so that it is necessary that its natural frequency be within the operational range of the washer. In order to be able to control resonance, it is necessary to have a pronounced acceleration ramp in the centrifuge cycle, to not grant the system time to be able to enter resonance. It is absolutely necessary that the washer not operate at the suspension's natural frequency.

“Balancing Elements”—The balancing elements are those parts of the washer which attempt to maintain the system at equilibrium. Ideally, to have a system which is completely balanced, symmetry of all the parts in all the components should occur, and additionally, it is desired that they all be symmetrically distributed. Given the unlimited number of restrictions, this is impossible. Given this, the balancing elements are divided into static and dynamic depending on the function they perform.

“Static Balance”—The elements of static balance are those which maintain the system in static equilibrium. For example, it is typical for the motor and the water pump to be found in a position which causes mass un-equilibrium. This causes the center of gravity of the sub-washer to shift towards the back part of the washer. To counter-arrest these unbalanced masses it is possible to place a counter-weight on the front part with a geometry such that it causes the center of gravity to return to the rotor's geometric center of gravity (rotating axis).

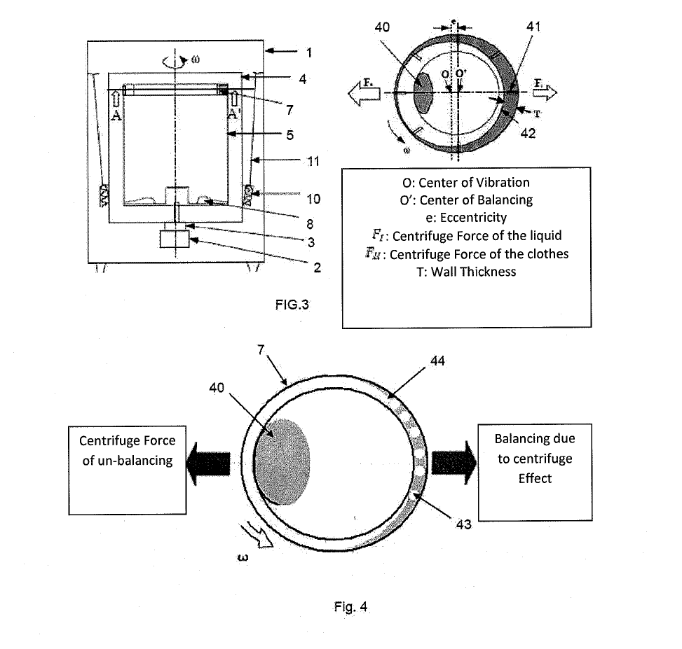

“Dynamic Balancing”—The elements of dynamic balance are those which react to different unbalancing conditions. The clearest example among these is when clothes within the washer are poorly distributed during the centrifuge cycle. Given that the rotor is turning, there is no way to place a static counter-weight which improves this condition. It is because of this that it is necessary to use other methods such as a flowing balancing ring. An upper balancing ring comprises a cavity in the shape of a ring which contains fluid within it. The cavity contains from fifty to eighty percent fluid. The fluid is distributed in such a way that it flows to the side opposite the unbalancing mass. FIG. 3 shows a diagram of the way in which a flowing balancing ring functions. Specifically, it can be seen how the clothes 40 tend to accumulate on one side of the basket 5 during the centrifuge stage, while the liquid surface 43 tends to accumulate on the side opposite the balancing ring 7. The force of the liquid F and the force of the clothes F1 help balance the system during centrifuge since the forces are opposite.

There are also solid balance rings. These rings are generally made of spheres which run along the length of a channel in the rotor. The functioning principle is the same as with the flowing balancing ring. The spheres are placed at the opposite side of the unbalancing mass. In FIG. 4 a sphere balancing ring 7 can be seen made of steel 43. The relationship that exists between the length and the diameter of a washer's rotor allows this to be classified as a long rotor. Considering this fact, it is possible that the washer be in need of two balancing planes. This will depend on the desired velocity and performance. FIG. 5 shows the balancing concept in two planes, and also shows the unbalancing forces and the counter forces to the same, the unbalancing forces on the upper and lower rings. It is possible that the balancing rings on both planes, both are solid or both are fluid or a combination. It is possible and even preferable to combine the steel spheres 43 with a viscous liquid with drag 44 to create a better balancing effect. A washer with two balancing planes will always behave better than its counterpart with only one sole plane.

### Influence of Parts on the Dynamic

Reiterating, the parts which are critical to the dynamic of the washer are: the rotor, tub 4, suspension 10 and the structure. The present application focuses solely on the suspension and its variables. The suspension is responsible for the dynamic behavior of the washer but is not the sole responsible component.

The present application uses a generalized methodology for the design of washer suspensions based on computer assisted engineering.

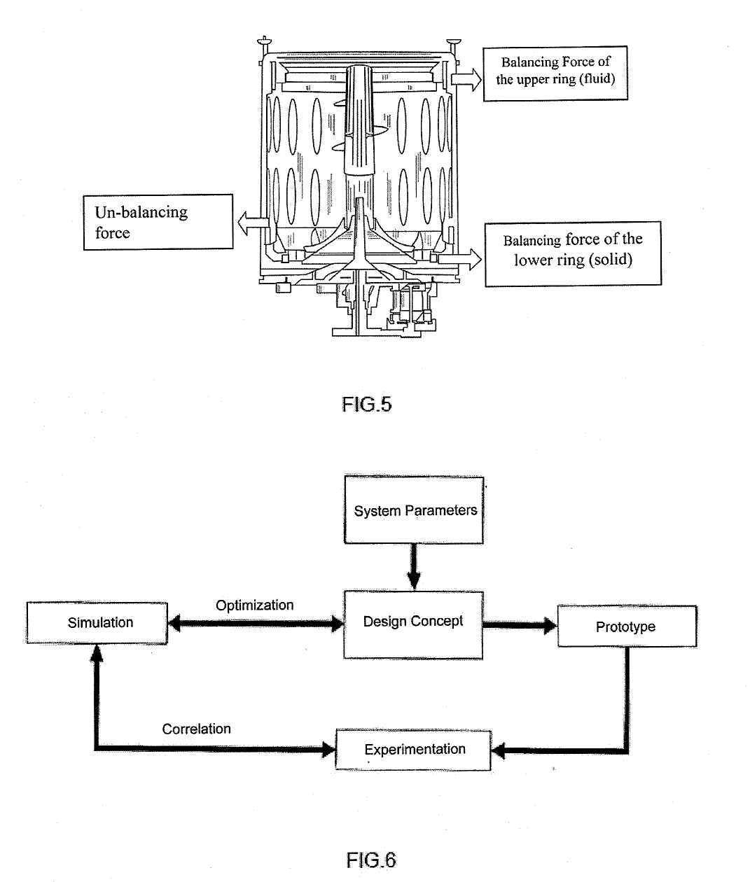

This methodology considers various aspects of the design and it relates them in such a way to improve the results in the best possible time. FIG. 6 shows a scheme of the proposal. As is observed in FIG. 6, the origins of the process are the system's parameters.

The methodology is constituted by the design parameters which feed four stages of the methodology. The stages are design concept, simulation, prototype elaboration and experimentation. These stages do not necessarily need to be successive since there are two retro-feedback processes: the correlation and the optimization.

The correlation is a process which exists between experimentation and simulation and involves validating simulation with the experimental results.

Optimization is the process by which the simulation gives rise to the modifications which shall improve the performance of the design concept. Following each one of the methodology parts is briefly described.

### System Parameters

The system parameters are those which describe the system, those that determine and restrict the function of the design. To have a better understanding of these parameters, they shall be divided into entry parameters (excitation) and exit parameters (response).

The entry parameters are those which are involved in the excitation of the system. These parameters are among others, the mass, the forces involved in the system's excitations, the rotational velocity, the rigidity etc.

The exit parameters are the result of the variations of the entry parameters. The exit parameters are classified into internal and external parameters. The internal parameters are related to the movement of the sub-washer in its 6 degrees of freedom. The internal exit parameters are among others, the re-bounce, the orbit, the angular orbit, the torque, the force that exists in the suspension rods etc. On the other hand, the external exit parameters are those which the operator perceives, such as vibration and the walking of the washer.

The design concept is the manner in which the problem of the suspension is proposed to be solved. In the suspension design there are two aspects proposed to be resolved, the suspension's topology (structure) and the design of the isolator (spring and shock absorber). The suspension's topology shall be determined by the way in which the links of the same are interconnected to the sub-washer and to the ground. One way of representing the topology of the suspension is by the use of diagrams. In these diagrams, the lines represent articulations and the vertexes represent links. In these diagrams, vertex G represents the cabinet of the washer and vertex T represents the tub of the washer. R, P, S, C and K represent the types of articulations of revolution, prismatic, spherical, cylindrical and universal respectively. The points between the articulations represent the links. Depending on the links and articulations used the suspensions can have only one degree of freedom, two degrees of freedom (plane) or three degrees of freedom (spatial).

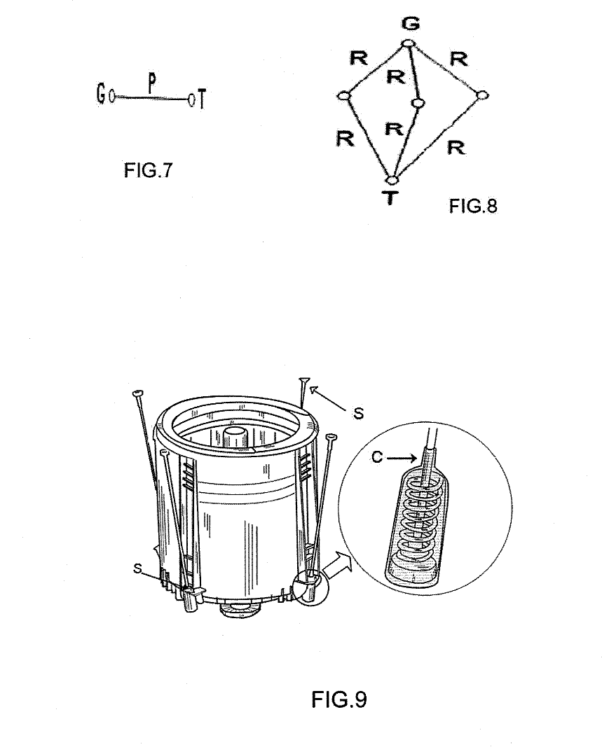

In the case of suspensions with only one degree of freedom, only the ascending and descending movement of the same are allowed. This type of suspension generally is subject to high forces in the articulations if the washer's rotor is incorrectly balanced. FIG. 7 shows a diagram of a suspension with only one degree of freedom. This implies that between the cabinet and the washer there only exists one prismatic articulation. Upon eliminating five degrees of freedom, the articulation would have to structurally absorb the forces and moments generated within these.

In the case of plane and spatial suspensions, it is necessary to add links. The simplest way of accomplishing this is to add link chains in parallel. FIG. 8 shows a link chain in parallel. Upon adding links it is possible to have a spatial topology which allows movements with more degrees of freedom. Adding links also implies adding articulations. With a parallel arrangement, it is possible to attain many degrees of freedom using articulations from only one degree of freedom.

The suspension's topology analysis also implies determining the number of degrees of freedom of the same. The calculation is performed in the following way:

For plane arrangements

G=3(n−1)−2ⁿ_{f}−2ⁿₚ (3)

For spatial arrangements

G=6(n−1)−5ⁿᵣ−5ⁿₚ−4ⁿ_{c}−4ⁿₖ−3ⁿₛ (4)

Where G represents the total number of degrees of freedom and nᵣ, nₚ, n_{c}, nₖ and nₛ are the number of rotational, prismatic, cylindrical, universal and spherical articulations respectively.

This calculation is very useful to investigate if there are redundant articulations. For example, a plane suspension despite its having movement along two degrees of freedom can have a redundant articulation and therefore have three degrees of freedom. Taking the suspension in FIG. 9 as an example, the diagram of the same would be that of FIG. 10. The calculation for the degrees of freedom is the following:

G=6(10−1)−4(4)−3(8)=14 (5)

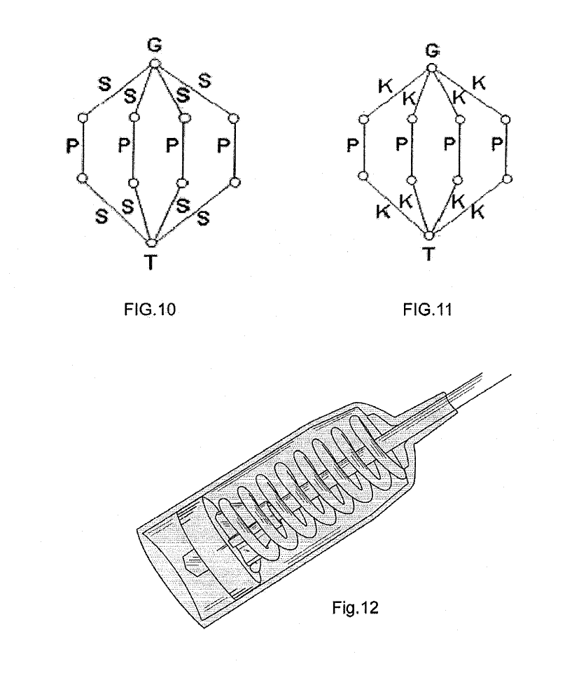

This means that despite the movements of the sub-washer being limited to six degrees of freedom, the suspension is delivering fourteen degrees of freedom. If it were desired to not have redundant articulations, the spherical articulations of the ends could be substituted by universal articulations. The diagram of a modification such as this is shown in FIG. 11.

The calculation for this arrangement would be:

G=54−4(4)−4(8)=6 (6)

In this way the suspension would deliver the necessary six degrees of freedom to allow all the movements of the sub-washer. It is worth mentioning that if a suspension does not deliver the degrees of freedom for the movement of a suspended body, the articulations will have to withstand the resulting forces of restricting the movements in certain directions.

On the other hand, the length and geometry of the links will determine the work space and the packaging of the suspension.

The purpose of vibration isolation is to control undesired vibration so that the adverse effects be kept within a certain limit.

The vibration originated by machines or other sources is transmitted towards a support structure such as the floor, causing undesired vibration levels. If the equipment which requires isolating is the source of the undesired vibration, the purpose of isolating is to reduce the vibration transmitted to the support structure. On the contrary, if the equipment which needs to be isolated is a receptor of unwanted vibration, the purpose of the isolation is to reduce the vibration transmitted by the support structure towards the receptor.

An isolator is a resilient support which decouples an object from a stable state or forced vibration. To reduce the transmitted vibration, isolators in the form of springs are used. The springs are commonly pneumatic, steel spire, rubber (elastomers) and other cushioned materials.

The natural frequency and the shock absorption are the basic components of an isolator which determine the transmissibility of a system designed to provide vibration isolation. Other factors to consider are the source and the type of disturbance which the vibration causes and the dynamic response of the isolator to the disturbance.

With an understanding of its properties, the type of isolator is chosen for the load which it supports and the dynamic conditions under which it shall operate, within theses dynamic conditions is found the natural frequency (Spring Constant), the shock absorption, the transmissibility and the practical isolation.

A computational isolation is an attempt to model reality or a hypothetical situation in a computer to be able to study and observe how the system works. Changing the variables allows arriving at predictions regarding the behavior of the system.

The washer simulation implies having the most complete model possible within the simulation packet. In this type of simulation the bodies are related amongst themselves through articulations and each body has geometric and inertial properties. To accomplish this, it is necessary to determine which aspects of the model are important and must be simulated.

The simulation of multi-bodies using rigid bodies is a good initial approximation to a system's dynamics. This type of simulation considers that all bodies involved in the mechanism cannot be flexed and are therefore rigid.

A simulation of rigid bodies tends to be faster and is used when it is known that the simulated mechanism presents low deflection.

A multi-body pre-processor is a program by which a mechanism's characteristics are introduced to a language to enable it to read and process a solution.

The pre-processor has various types of entities. The main entities of a mechanism are the bodies, the articulations and the movements (actuated articulations). The remaining entities help to add detail to the model of the mechanism. The bodies within a multi-body simulation can be of two types, rigid and flexible. The difference between these two types of bodies is the behavior they exhibit when force is applied on them. The post-processor is the element which allows verifying the results of the simulation and if it is compared to real experimental measurements it can determine if the virtual model loyally describes the real model.

The dynamic analysis with flexible bodies delivers two important results, the system's dynamics and the structural condition of the components during movement. That is, the condition of forces and deformations of the components can be predicted which could not be seen in a static analysis.

To produce a prototype is the process through which a functional model is made of a device with the objective to test various aspects of the design, to illustrate ideas or characteristics and to obtain retro-feedback from the operator.

The experimentation is a very important stage of the design since it puts to test the designed system's performance. In the case of washers, measurements are taken of the dynamic events. For this reason, electronic devices are used which are capable of obtaining a sample through the length of time of the dynamic event. Measurement of entry parameters takes place. Afterwards, measurement of exit parameters takes place.

Correlation is the process through which simulations are validated by experimental measurements. It should be highlighted that with nonlinear phenomena it is difficult to obtain a perfect correlation because on occasion it is necessary to manipulate the data to attain better adjustment.

The variables to be correlated depend on the feasibility of these to be measured and of the possibilities for software simulation to obtain them. Generally, the simplest variables to correlate are the forces and the displacements.

The process of optimizing for the optimizing of suspension design, the variables to be optimized can be diverse depending on the problem to be resolved. The main variables which can be subject to be optimized in these types of problems are rigidity, shock absorption and topology.

### First Embodiment

The suspension of the first embodiment is a hanging suspension 10 with four series of links 15, 16, 18. The series of links hang from the upper corners of the washer's cabinet 1 and are coupled by means of a lower foot 20 at four lower points of the tub 4 of the washer or to the ground. Between each one of the links, there is an articulation 14, 17, 19, 21. On each articulation there is a housing 25 to house a spring 22. Each spring limits the rotation of each one of the links and the rotation of each one of the articulations.

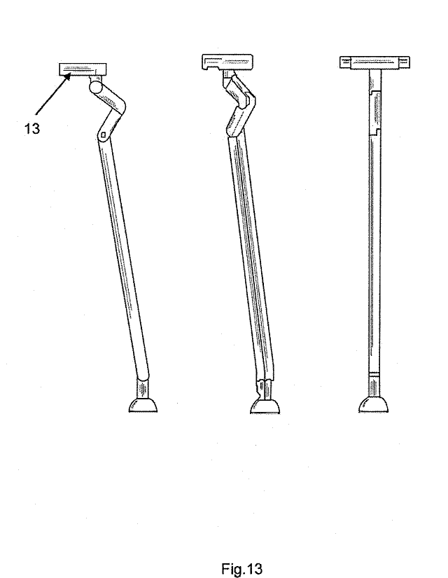

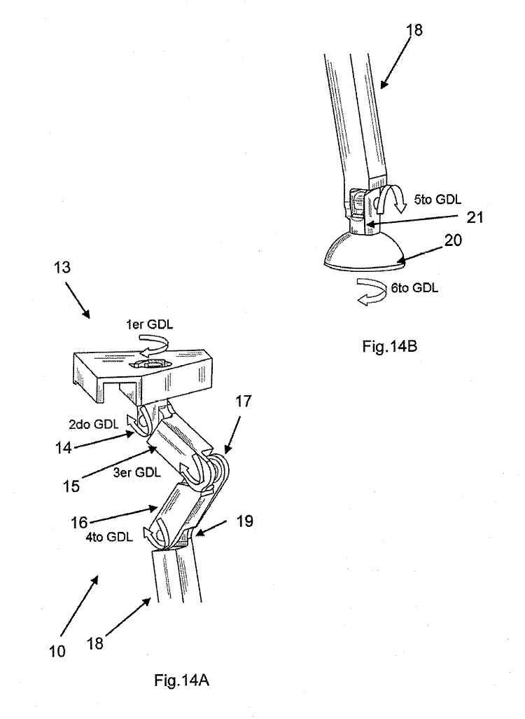

In the suspension, rotational articulations and one link chain are used exclusively to provide the six degrees of freedom. FIG. 13 shows the concept of links and rotational articulations.

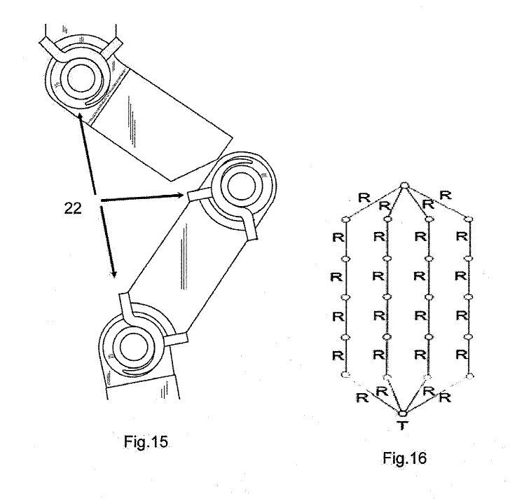

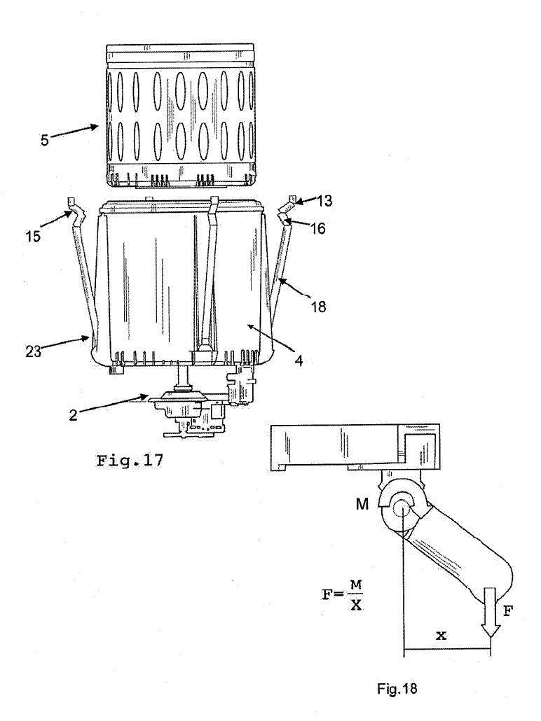

The upper part of the Cardan joint 13 is coupled to the cabinet's 1 corner and the lower part of the tub's 4 ear. FIG. 14A shows the degrees of freedom of the proposed concept. This FIG. 14A shows the upper part of the suspension, specifically the Cardan joint 13 which will be coupled to the cabinet. Similarly, each one of the four degrees of freedom on the upper part of the suspension 10 is shown. The first degree of freedom (1^{st} DOF) is attained between the suspension and the cabinet. The 1^{st} DOF is in rotational direction Y. The second degree of freedom (2^{nd} DOF) is attained between the Cardan joint 13 and the first link 15 by means of the first articulation 14. The rotation of the 2^{nd} DOF is in a rotational direction X. The third degree of freedom (3^{rd} DOF) is attained by the first link 15 and the second link 16 by means of the second articulation 17. The rotation of the third DOF is in a rotation similar to that of the 2^{nd} DOF. The fourth degree of freedom (4^{th} DOF) is attained by the second link 16 and the third link 18 by means of the third articulation 19. The rotation of the fourth DOF is in a rotation similar to that of the 2^{nd} and 3^{rd} DOF. FIG. 14B shows a lower part of the suspension, specifically the foot 20 which will be coupled to the tub. The fifth degree of freedom (5^{th} DOF) is attained by the third link 18 and the foot 20 by means of the fourth articulation 21. The rotation of the fifth DOF is in a rotation similar to that of the 2^{nd}, 3^{rd} and 4^{th} DOF. The foot 20 comprises two parts. A first part which is fixed respective to the tub and a second part which rotates according to the fourth articulation 21. In this way, the sixth degree of freedom (6^{th} DOF) is attained between the two parts of the foot 20. The rotation of the 6^{th} DOF is in a direction similar to that of the first DOF.

The suspension works with a spring shock absorber system. Such as is shown in FIG. 15, torsion springs 22 are housed in each one of the rotational articulations 14, 17, 19, 21. The springs 22 work when the suspension moves from its assembly position and the springs act to return to the original position. The shock absorption is found within the rotational articulation. This shock absorption is attained through the friction in the axis of the articulations. The topology is represented through a scheme such as is shown in FIG. 16.

FIG. 17 shows it all apart with the main bodies. Each suspension ensemble is divided into five main parts: the upper Cardan joint 13, first link 15, second link 16, third link 18 and lower Cardan joint 23. As was previously mentioned there is a spring 22 on each one of the rotational articulations 14, 17, 19, 21 of the suspension. Thus the list of bodies is: ground, all the upper Cardan joints, all the primary links, all the secondary links, all the tertiary links, all the lower Cardan joints, the tub assembly, the motor assembly and the basket assembly. The articulations need points of reference to be able to be introduced into the simulation. These points refer to the position of the articulation of the turning or translation vectors and the orientation.

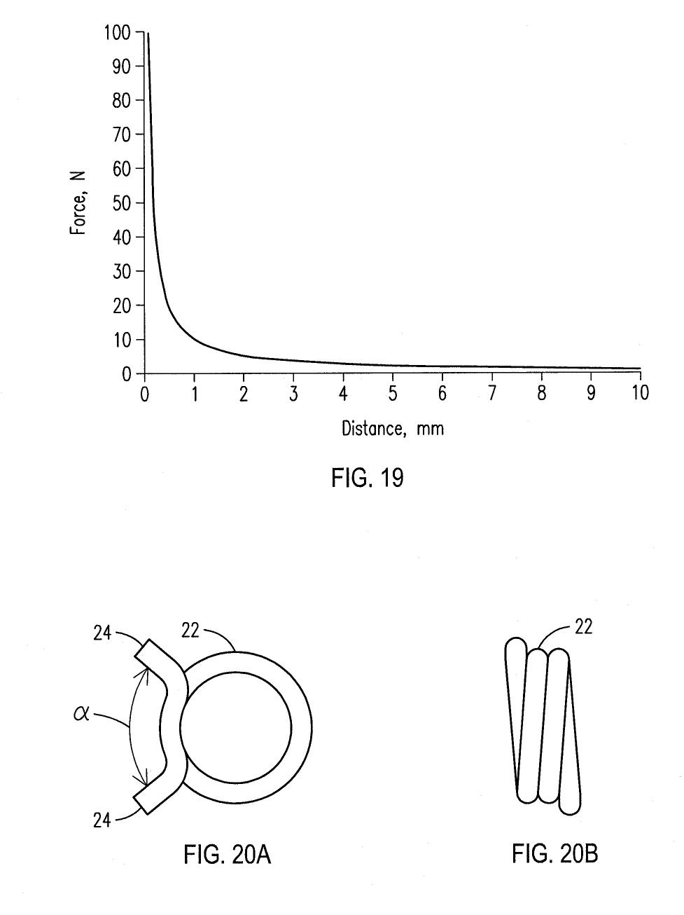

There is a spring and a shock absorber on each one of the rotational articulations. The springs are a constant of torsion rigidity and a free angle of the position of suspension assembly. The combination of torsion springs and the suspension's topology make the total rigidity of the suspension be nonlinear. This phenomenon is explained in the diagram in FIG. 18. In this FIG. 18 it is explained that the momentum (M) of the articulation between the distance (X) of travel of the corresponding link, which also corresponds to the length of the link, will be equivalent to the force of movement (F). Making the calculations of the resulting force depending on the distance (X) of the links and knowing that the momentum (M) is constant, results in the curve in FIG. 19.

To determine a rigidity constant for the springs, the value of the constant is varied until obtaining the desired behavior.

A critical part of the suspension's design in the first embodiment is the springs and the housing of the springs. To achieve this design, it was thought that the springs have to work in both directions. To achieve this in the prototype a torsion spring was used of the type shown in FIGS. 20A and 20B. Specifically, given that the ends of the links have the articulations and that the torsion springs 22 are placed on said articulations, the protrusions 24 of the torsion springs fasten between themselves the corresponding link. In this way, when the springs 22 are at work they limit the movement of the articulations and the movement of the links. It is preferred that the angle α, which is the angle between the two lateral ends of the links, be between 60° and 89° and more preferably that the angle α lie between 75° and 85°.

The housing 25 of the spring has the capability of making the torsion spring 22 work in both directions. Each one of the links 15, 16, 18 comprises one articulation 14, 17, 19, 21 in which there is one housing 25 for the torsion spring 22. FIG. 21 shows a detail of the housing 25 for the springs.

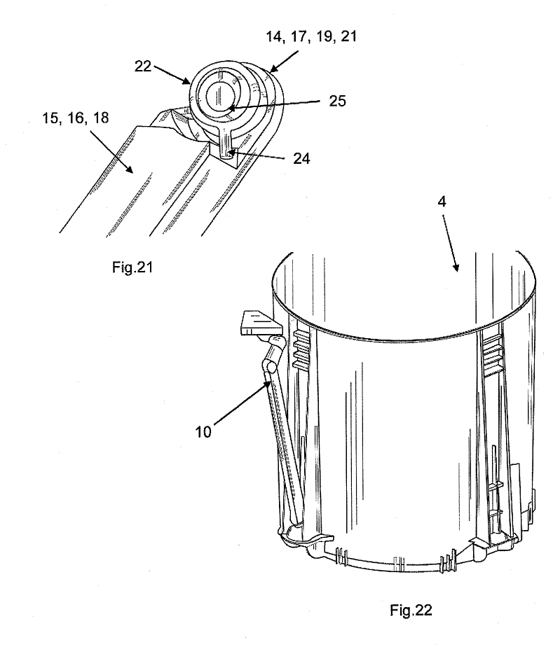

The first embodiment's suspension, mounted on the tub 4 is shown in FIG. 22.

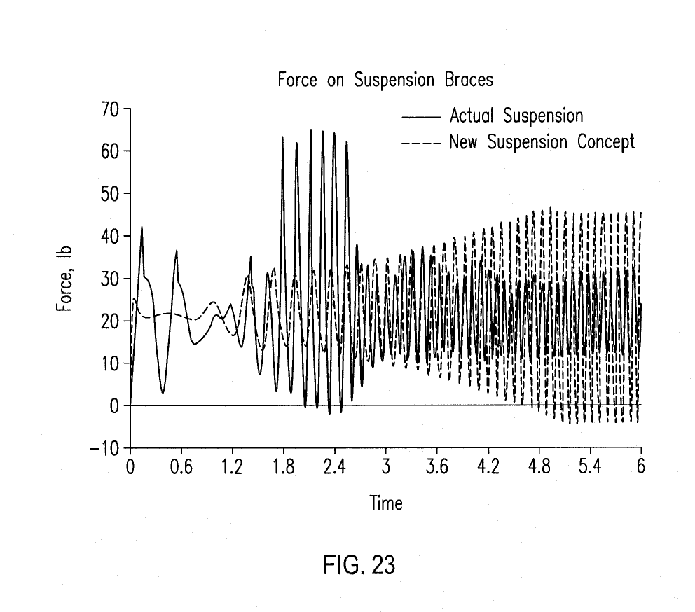

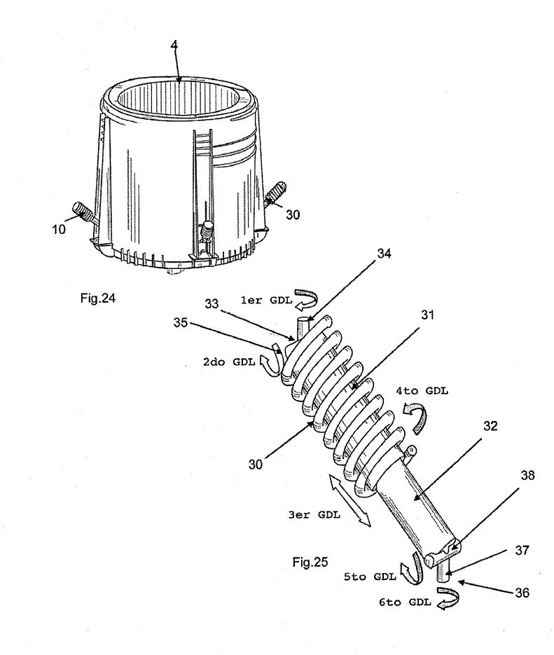

FIG. 23 shows a force graph with braces of the suspensions in previous art and the suspension of the first embodiment.

It is observed that in the transitory state, the first embodiment has better behavior than the suspension in previous art. However, in a stable state there exists an increase in force.

### Second Embodiment

The suspension of the second embodiment 10 is a hanging suspension with four equal assemblies. The assemblies hang from a substantially centric part of the lateral walls by means of a Cardan joint 13, front and back of the cabinet 1 and are coupled by means of an articulation in four points to said walls of the cabinet 1 by means of a foot 20. The Cardan joint 13 and the foot 20 are grasped by means of fasteners known in the art, such as rivets, screws, welding by any means, means of interference, treading (bearings), etc.

In an alternative embodiment the Cardan joint 13 is grasped unto the ground.

On the opposite end, the suspension 15 is coupled to the bottom of the tub 4 of the washer by means of one articulation. Surrounding said suspension, a spring is found. The suspension comprises two parts, a piston and a cylinder. The articulations comprise two universal joints (2 DOF in each one) and one cylindrical articulation (2 DOF).

Similar to the first embodiment, the second embodiment is capable of controlling the six degrees of freedom of the sub-washer. The second embodiment is shown in FIG. 24. This embodiment has the advantage of using one sole linear spring 30 on each suspension assembly which provides the rigidity of the six degrees of freedom.

The way in which the spring 30 provides the rigidity for any kind of movement is through the four assemblies of the suspension 10. Any movement of the sub-washer, translational or rotational, causes a positive or negative deflection to the springs 30 of the four assemblies. This is achieved through the concept that a rotational movement is a consequence of two translational movements in different parts of the body. FIG. 25 shows the degrees of freedom in the second embodiment.

The first degree of freedom (1^{st} DOF) is given between the cabinet's 1 corresponding wall and the first articulation 33 by means of the first portion 34 of the articulation 33. The 1^{st} DOF has a rotational direction Y. The second degree of freedom (2^{nd} DOF) is attained between the first articulation 33 and the cylinder 31 by means of the second portion 35 of the articulation 33. The 2^{nd} DOF has a rotational direction X substantially perpendicular to the rotational direction Y. The third degree of freedom (3^{rd} DOF) is attained between the cylinder 31 and the piston 32 by means of the movement between the piston 32 according to the cylinder 31. As opposed to the rotational differences of X and Y, the 3rd DOF has a linear direction along the length of the cylinder. The fourth degree of freedom (4^{th} DOF) is also attained between the cylinder 31 and the piston 32 by means of the rotational movement between the piston 32 according to the cylinder 31. The 4^{th} DOF has a direction around the cylinder. The fifth degree of freedom (5^{th} DOF) is attained between the second articulation 36 and the piston 32 by means of the second portion 38 of the articulation 36. The 5^{th} DOF has a rotational direction similar to the 2^{nd} DOF. The sixth degree of freedom (6^{th} DOF) is attained between the lower portion of the tub 4 and the second articulation 36 by means of the first portion 37 of the articulation 36. The 6^{th} DOF has a rotational direction similar to the 1st DOF.

By having four coupling points to the sub-washer's body, the rotational movements of the same shall be transformed into linear movements in the assemblies of the suspension and due to this, only linear springs are used.

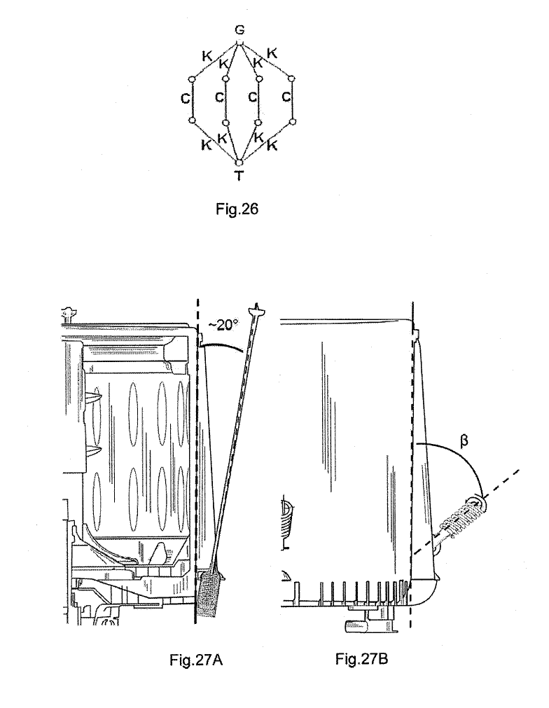

The second embodiment has a control on the system's 6 degrees of freedom via another type of articulations. FIG. 26 shows a topology scheme of the suspension using universal and translational articulations.

Equation 7 proves that the six degrees of liberty are provided through Gruebler's equation:

G=6(10−1)−4(8)−4(4)=6 (7)

In the second embodiment, the design of the isolator is simplified and it simulates the suspension of previous art. It is exclusively a linear spring. The difference lies in the inclination angle of the spring as it relates to the sub-washer. For the suspension of previous art the spring is found bearing the sub-washer's weight almost in parallel to the sub-washer's body. That is, in the previous art suspension, the spring is found at a 20° angle. In the second embodiment, the spring is at an angle β, where β is found to be between 35° and 50° from the sub-washer and more preferably between 42° and 47° from the sub-washer, which causes that on top of bearing the weight it also provides a force to the outside. These differences are shown in FIG. 27A which shows the previous art and FIG. 27B which shows the second embodiment.

For this reason the spring in the new concept has a greater rigidity constant. This rigidity is iterated through the simulation software.

As far as the shock absorption, a constant shock absorber similar to that of the suspension of the previous art is considered. Additionally, shock absorption is added to the universal articulations 33, 36 to provide a smoother movement.

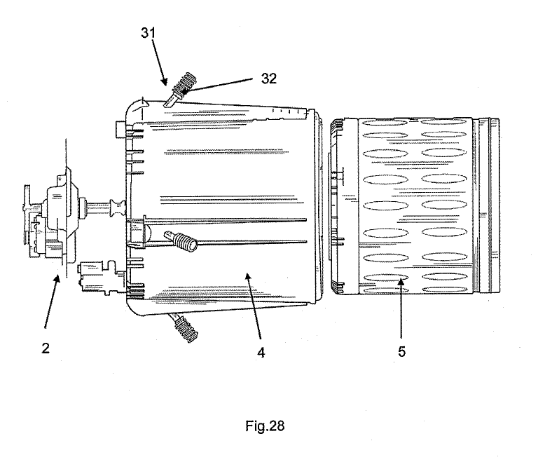

The second embodiment changes the bodies which participate. FIG. 28 shows a diagram with the pieces cut up identifying the main bodies.

Each suspension assembly is divided into two parts: cylinder 31 and piston 32. There is a linear spring 30 in the cylindrical articulation between the cylinder and the piston. The participating bodies are the ground, the four cylinders, the four pistons, the tub assembly, the motor assembly and the basket assembly.

For the second embodiment of the suspension there exist a lesser number of articulations but with greater degrees of freedom. Specifically, the articulations present per each suspension is a universal articulation which grants two degrees of freedom found between the ground and the piston, one cylindrical articulation which grants two degrees of freedom and is found between the piton and the cylinder, one universal articulation which grants two degrees of freedom and is found between the tub and the cylinder, one fixed articulation between the motor assembly and the assembly which does not grant any degrees of freedom and a revolution articulation between the tub assembly and the basket assembly which grants one degree of freedom. The articulations need points of reference to be able to be introduced into the simulation. These points refer to the position of the articulation vectors of gyration and orientation.

Only one linear spring between the piston and the cylinder is found present. The spring is a constant of linear rigidity and has a free length.

In the case of the shock absorber, two models are used; viscous shock absorber and shock absorber by friction.

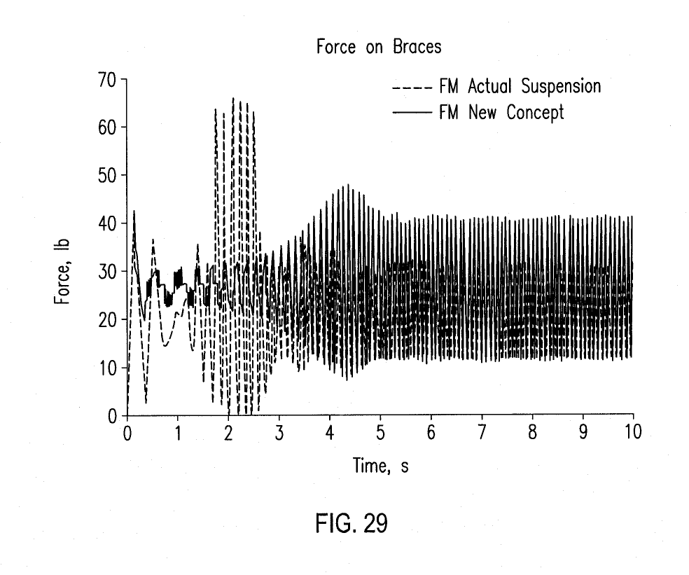

The suspension of the previous art was compared to that of the second embodiment, both in forces on the braces as well as the sub-washer's displacements. FIG. 29 shows a force comparative between the suspensions of the previous art against that of the second embodiment using shock absorption by friction. From FIG. 29 it can be seen that the second embodiment offers an improvement in the transitory state. However, the initial charge increases due to the angle of the suspension and in the transitory state there is a force increase of approximately 10 (lbf) point to point.

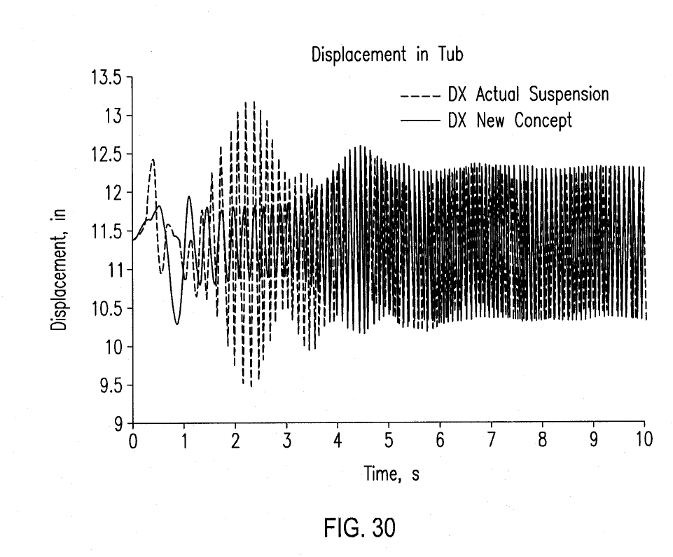

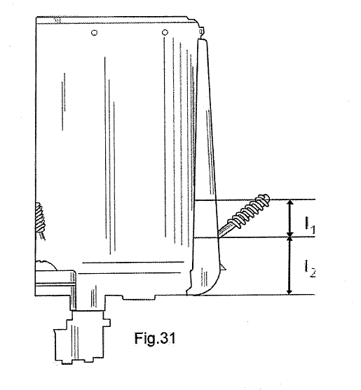

In so far as the tub displacements, FIG. 30 shows the results of the comparative between the previous art suspension and that of the second embodiment. The second embodiment shows an improvement in the transitory state and a similar behavior along the length of the stable state.

The optimizing of the second embodiment is oriented to the position and the angle in which the suspension is found. It has been observed that a greater angle between the sub-washer and the suspension improves the transitory state but harms the stable state. In the same way, it has been observed that the height at which the suspension is coupled to the sub-washer can benefit or harm the behavior. Due to this, optimization was made with respect to these variables. FIG. 31 shows a scheme of the variables to be optimized.

The entry variables will be the lengths l₁ and l₂ shown in FIG. 31. To be able to fix in a more effective way the limits of the variables, the following wide ranges are provided in Table 1:

TABLE 1

| | Initial | Minimum | Maximum | |
|---|---|---|---|---|
| Variable | Value | Value | Value | Levels |
| Distance 1₁ | 0 | −1 | 12 | 10 |
| Distance 1₂ | 3.24 | 2.91 | 10 | 5 |

Making all the possible interactions with the declared levels for each variable gives a total result of 50 runs. Following, in Table 2, a fraction of the results is shown:

TABLE 2

| Run# | l1 | l2 | Displacement | Force |
|---|---|---|---|---|
| 1 | −1 | 2.916 | 5.166 | 51.139 |
| 2 | −1 | 4.687 | 2.448 | 45.918 |
| 3 | −1 | 6.458 | 2.487 | 45.910 |
| 4 | −1 | 8.229 | 2.417 | 45.318 |
| 5 | −1 | 10 | 2.317 | 44.062 |
| 6 | 0.444 | 2.916 | 4.098 | 87.980 |
| 7 | 0.444 | 4.687 | 2.410 | 45.018 |
| 8 | 0.444 | 6.458 | 2.466 | 44.952 |
| 9 | 0.444 | 8.229 | 2.436 | 44.461 |
| 10 | 0.444 | 10 | 2.372 | 43.750 |
| 36 | 9.111 | 2.916 | 4.427 | 56.968 |
| 37 | 9.111 | 4.687 | 1.916 | 41.659 |
| 38 | 9.111 | 6.458 | 1.963 | 41.016 |
| 39 | 9.111 | 8.229 | 2.006 | 39.643 |
| 40 | 9.111 | 10 | 2.043 | 38.935 |
| 41 | 10.556 | 2.916 | 1.982 | 45.164 |
| 42 | 10.556 | 4.687 | 1.917 | 42.011 |
| 43 | 10.556 | 6.458 | 1.929 | 41.351 |
| 44 | 10.556 | 8.229 | 1.998 | 40.126 |
| 45 | 10.556 | 10 | 1.980 | 39.208 |
| 46 | 12 | 2.916 | 2.028 | 45.406 |
| 47 | 12 | 4.687 | 1.911 | 42.481 |
| 48 | 12 | 6.458 | 1.916 | 41.723 |
| 49 | 12 | 8.229 | 1.935 | 40.254 |
| 50 | 12 | 10 | 1.920 | 39.482 |

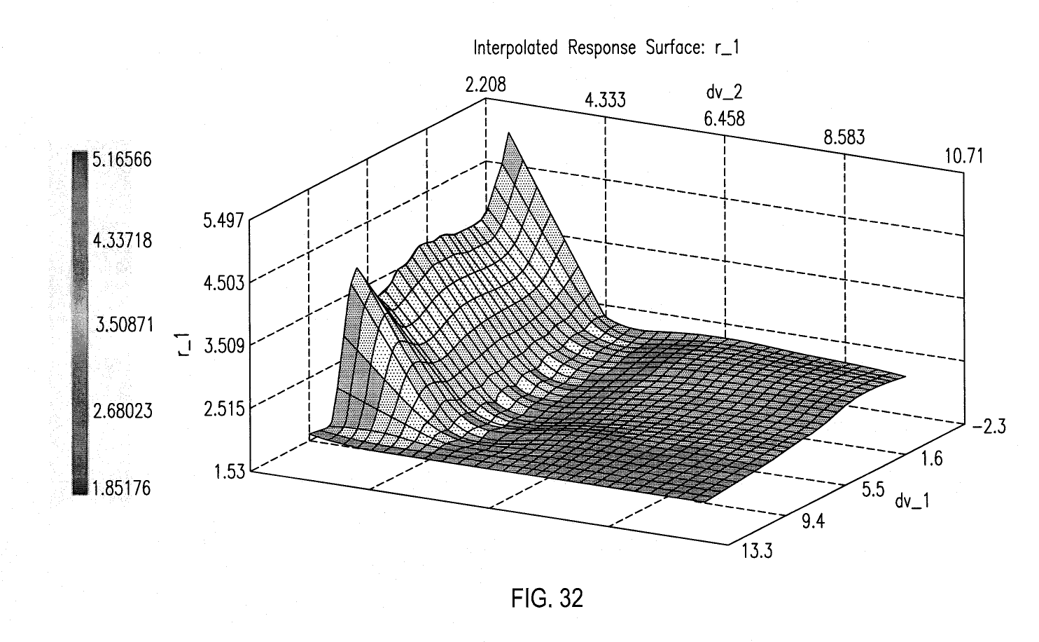

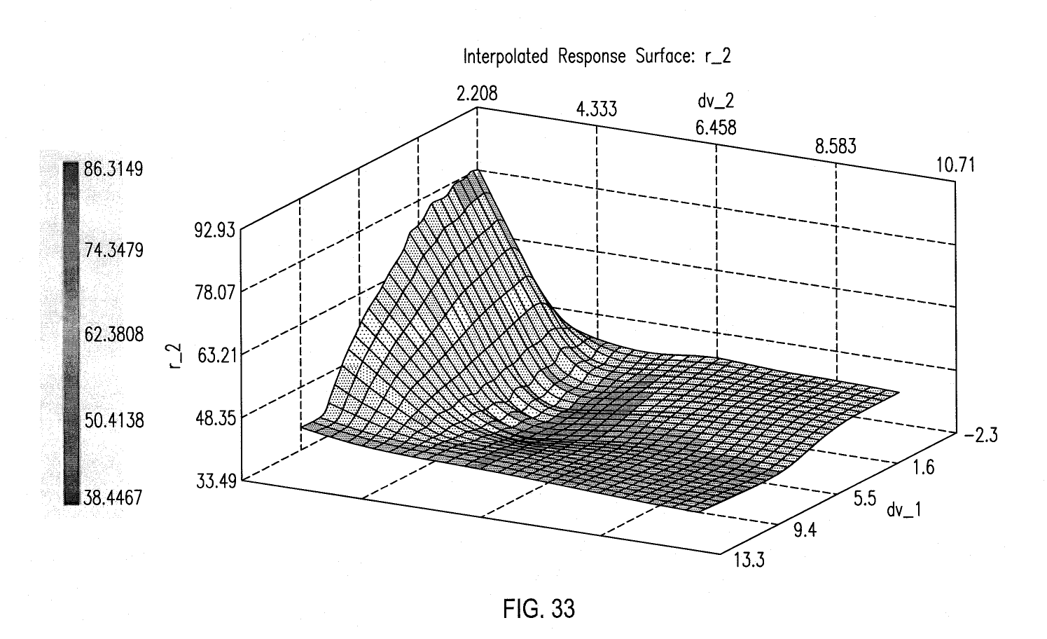

In these results there is not a clear case better than another. There exist many similar cases. For this reason, a post-processing of the data was done and graphed on a response surface. FIG. 32 shows the response surface for displacement. The X and Y axis represent the two entry variables and Z represents displacement. The surface shows that for values l₁ between 9 and 5 and values l₂ between 4 and 6, there is a depression on the surface and as such a diminishing displacement.

Making the same procedure for the force response, in FIG. 32 for the force response, FIG. 32 shows the surface response for this parameter. In this case, the Z axis represents the force. It is observed that the minimum is found within a similar range to that of the displacement. Via this procedure, it is possible to reduce the range of the entry variables. Thus, to optimize the parameters for the variables they remain in the following manner in Table 3:

TABLE 3

| Variable | Initial Value | Minimum Value | Maximum Value |
|---|---|---|---|
| Distance 1₁ | 2 | 2 | 12 |
| Distance 1₂ | 4 | 4 | 10 |

With the objective of observing if an optimized displacement value delivers an acceptable force value, only the displacement value was restricted from a point to a point of displacement in the tub lesser than or equal to 1.96 (in).

The displacement minimizing results for the tub are shown in the following Table 4. The first iteration does not comply with the restrictions. The second iteration does comply with the restrictions.

TABLE 4

| Iteration | 1₁ | 1₂ | Objective | Displacement | Force |
|---|---|---|---|---|---|
| 1 | 2.000 | 4.0000 | 45.3503 | 45.3503 | 40.6167 |
| 2 | 8.911 | 4.1877 | 1.9071 | 1.9071 | 41.3571 |

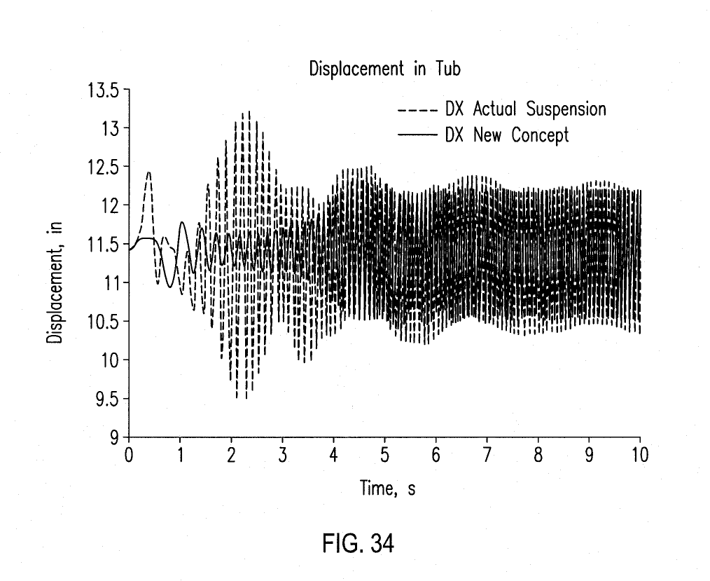

Once the values of all variables are obtained, it is possible to verify that both displacements as well as force are improved when compared to the base line. FIG. 34 shows a graph with displacements comparing the base line and the new optimized concept. A notable improvement can be seen in the transitory state and a better control in the stable state.

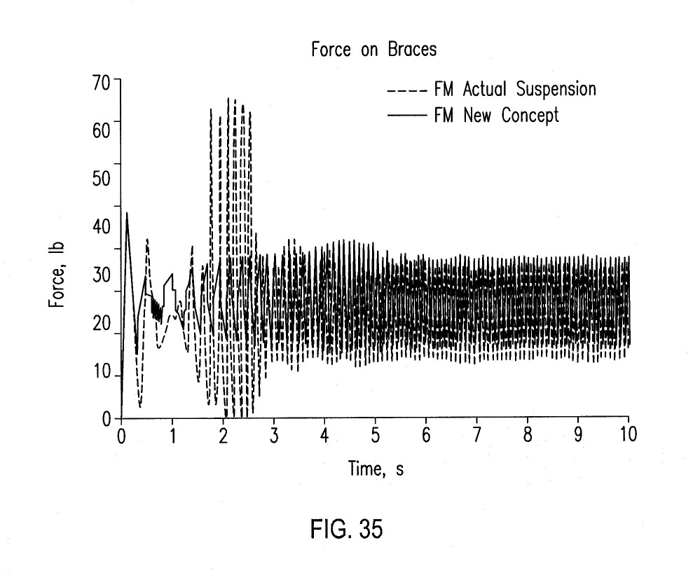

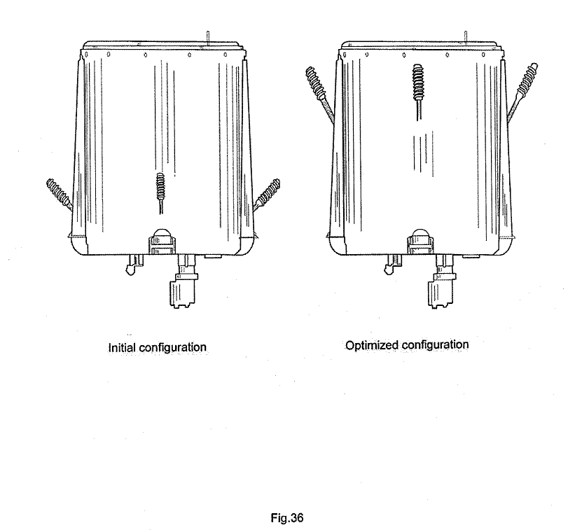

On the other hand, the one in FIG. 35 shows the force comparative in the suspension's rod. It can be seen that there is an improvement in the force for the transitory state and a slight increase in the stable state. However, the force increase in the stable state is due to the initial load being slightly greater in the iteration of the second embodiment. The force from point to point is kept equal to the suspension in previous art.

Finally, FIG. 36 represents a comparative between the initial configuration of the second embodiment and the second embodiment, where the initial configuration is supported to the tub in a portion substantially lower regarding the tub, and where in the optimized configuration it is supported to the tub in a substantially higher portion regarding the tub.

The second embodiment can be further enhanced and more optimizations be made to different variables. For example, an optimization could be made regarding the shock absorption or the rigidity.

The model made for this application will be used by the applying company to verify the project designs in the washer area. The model has shown its practicality and utility to predict washer behavior and its parts under test conditions. It has turned into a further step for verifying the designs and changes which are made to existing platforms.

While the previous description contains many specific facts, these specific facts must not be considered as limitations within the reach of the invention, but simply as examples of the described embodiments. Those with expertise in the field of suspensions shall be able to visualize many other variations and different possible reaches, which shall lie within the invention's reach.

1-19. (canceled)

20. A suspension comprising at least four respective series of links coupled to support a system subject to vibration, each respective series of links comprising:
a Cardan joint and a foot;
a first articulation between the Cardan joint and a corresponding link;
an articulation between any two successive links; and
a further articulation between the foot and a corresponding link;
wherein each articulation houses a spring.

21. The suspension according to claim 20, wherein the Cardan joint is mechanically coupled to an upper part of a cabinet.

22. The suspension according to claim 20, wherein the Cardan joint is mechanically coupled to ground or to a lower part of a cabinet.

23. The suspension according to claim 20, wherein the Cardan joint articulation is arranged to rotate parallel to an upper surface of the Cardan joint.

24. The suspension according to claim 20, wherein the foot is mechanically coupled to a link and to an ear of said system subject to vibration.

25. The suspension according to claim 24, wherein said further articulation of said foot rotates in a plane parallel to the plane of said ear.

26. The suspension according to claim 20, wherein each one of said articulations between each one of the links rotates in a plane perpendicular to an upper surface of the Cardan joint.

27. The suspension according to claim 20, wherein the spring is a torsion disc or a heliocoid spring.

28. The suspension according to claim 20, wherein the spring is a torsion disc with two protrusions or notches, wherein each protrusion or notch is coupled to an end of each link, wherein the protrusions or notches have an angle between them in a first range from 60° to 89° or in a second range from 75° to 85°.

29. The suspension according to claim 20, wherein the spring is a torsion spring with at least two fasteners, wherein each fastener is coupled to an end of each link, wherein said at least two fasteners have an angle between them in a first range from 60° to 89° or in a second range from 75° to 85°.

30. A cylinder and piston suspension coupled to a system subject to vibration, said suspension comprising:
a cylinder with a first end and a second end;
a piston housed in the first end of the cylinder, the piston having a first end and a second end, wherein the first end of the piston is housed within the cylinder;
a first articulation mechanically coupled to the second end of the cylinder and to a Cardan joint;
a second articulation mechanically coupled to the second end of the piston and to a foot; and
a spring having a first end and a second end, wherein the first end is fastened to the cylinder and the second end is fastened to the piston;
wherein the cylinder suspension varies in a range from 35° to 50° relative to an axis of symmetry of the system subject to vibration.

31. The suspension according to claim 30, wherein the cylinder suspension varies in a range from 42° to 47° relative to the axis of symmetry of the system subject to vibration.

32. The suspension according to claim 30, wherein the suspension is coupled by way of the foot to the system subject to vibration in a substantially lower part of the system subject to vibration.

33. The suspension according to claim 30, wherein the suspension is coupled by way of the foot to the system subject to vibration in a substantially higher part of the system subject to vibration.

34. The suspension according to claim 30, wherein the Cardan joint is fastened to a substantially higher part of a cabinet or a lateral part of the cabinet.

35. The suspension according to claim 30, wherein the Cardan joint is fastened to the ground.

36. A washer which comprises the suspension according to claim 20.

37. A washer which comprises the suspension according to claim 29.

39. A washer which comprises the suspension according to claim 30.
